(19) United States
(12) Patent Application Publication
(10) Pub. No.: US 2020/0307471 A1
(43) Pub. Date: Oct. 1, 2020

(54) Red Light Camera Privacy Screen

(71) Applicant: Jose Manuel Chanfrau, IV, Miramar, FL (US)

(72) Inventor: Jose Manuel Chanfrau, IV, Miramar, FL (US)

(73) Assignee: Silentium, LLC, Miami Beach, FL (US)

(21) Appl. No.: 16/194,364

(22) Filed: Jan. 23, 2019

(51) Int. Cl. B60R 13/10; G02B 1/04; G09F 19/14

(52) U.S. Cl. CPC B60R 13/105; G09F 19/14; G02B 1/04

(57) ABSTRACT

The invention is a cover for a vehicle license tag made of a clear shatter resistant synthetic polymer plastic covered in the inside with a polarized sheet of plastic material similar to what is used to protect contents on computer screens from prying eyes. The plastic privacy screen, will be affixed to the bumper with screws. The privacy screen prevents viewing from the top or bottom at angles of 30 degrees or greater while permitting the tag to be viewed if looked straight on.

### REFERENCE TO RELATED APPLICATIONS

This application claims an invention which was disclosed in Provisional Application No. 62/763,628 filed Jun. 25, 2018, entitled “Red Light Camera Privacy Screen”. The benefit under 35 USC § 119(e) of the United States provisional application is hereby claimed, and the aforementioned application is hereby incorporated herein by reference.

### BACKGROUND OF THE INVENTION

### 1. Technical Field of the Invention

The present invention relates to an apparatus and method for shielding a tag from red light camera systems. More specifically, the invention relates to a cover for a vehicle license tag made of a clear shatter resistant synthetic polyurethane covered in the inside with a polarized sheet of plastic privacy screen material similar to what is used to protect contents on computer screens from prying eyes by blocking light from being reflected back to the red light camera.

### 2. Summary of the Invention

Because the camera is on a pole, it must take the photo of the vehicle from a downward angle. It is the fact that the red light camera must take the photograph from a downward angle that allows the Red Light Camera Privacy Screen to block light from being reflected from the tag.

### 3. BRIEF DESCRIPTION OF THE DRAWINGS

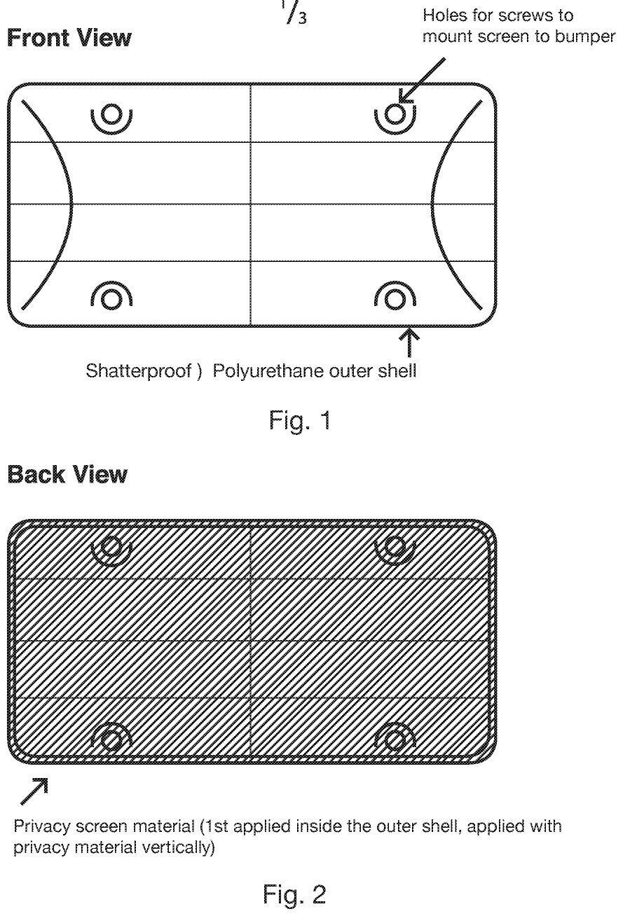

a. FIG. 1 is a view looking into the front of the polyurethane outer shell that protects the polarized sheet of plastic film used light blocking action of the Red Light Camera Privacy Filter.

b. FIG. 2 is a back view of the Red Light Camera Privacy Filter.

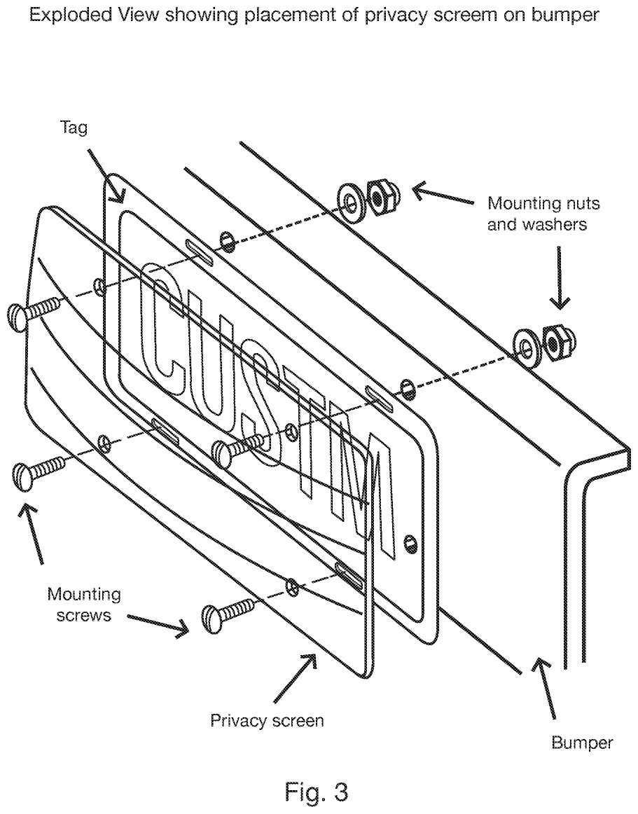

c. FIG. 3 is an exploded view of the Red Light Camera Privacy Filter.

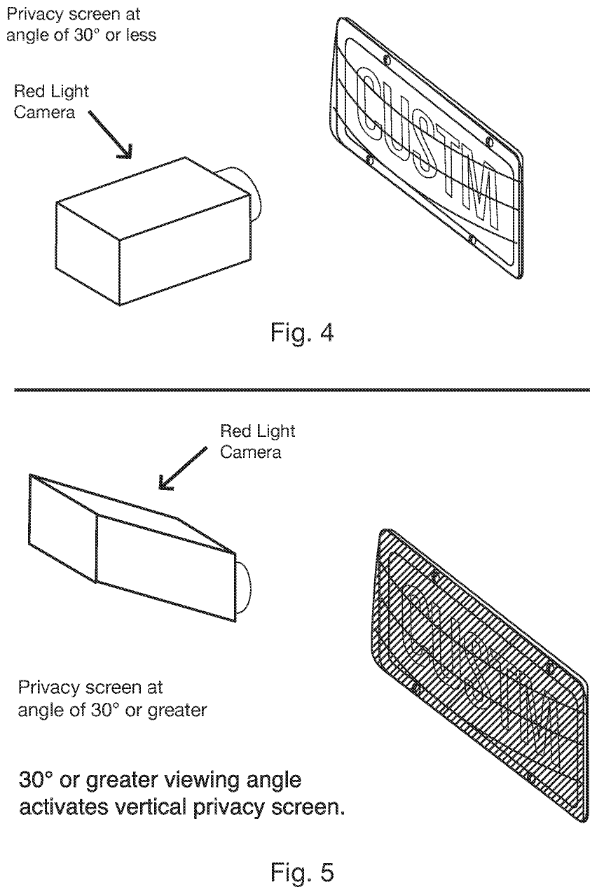

d. FIG. 4 is a view of the red light camera looking straight on to the tag with the Red Light Camera Privacy Filter is fitted over the tag.

e. FIG. 5 is a view of the red light camera looking at the tag when the viewing angle is more than 30 degrees.

### 4. DETAILED DESCRIPTION OF THE DRAWINGS

a. FIG. 1 is a view looking into the front of the polyurethane outer shell that protects the plastic film used light blocking action of the Red Light Camera Privacy Filter. The polyurethane outer shell is fitted with holes for the screws that will be used to affix the Red Light Camera Privacy Filter to the vehicle's bumper.

b. FIG. 2 is a back view of the Red Light Camera Privacy Filter showing the privacy screen material that is applied vertically to the inside of the polyurethane outer shell.

c. FIG. 3 is an exploded view of the Red Light Camera Privacy Filter showing the manner in which the Red Light Camera Privacy Filter is fitted over the tag and secured with screws, nuts and washers to the vehicle's bumper.

d. FIG. 4 is a view of the red light camera looking straight on to the tag with the Red Light Camera Privacy Filter is fitted over the tag. When the viewing angle is less than 30 degrees, there is no light blocking action by the Red Light Camera Privacy Filter and the tag can be seen.

e. FIG. 5 is a view of the red light camera looking at the tag when the viewing angle is more than 30 degrees, the light blocking action by the Red Light Camera Privacy Filter is in place and the red light camera cannot see the tag because light reflected from the tag is blocked by the Red Light Camera Privacy Filter and the tag cannot be seen.

### 3. DETAILED DESCRIPTION OF THE INVENTION

It is to be understood that the embodiments of the invention herein described are merely illustrative of the application of the principles of the invention. Reference herein to details of the illustrated embodiments is not intended to limit the scope of the claims, which themselves recite those features regarded as essential to the invention. The most common type of red light camera currently being employed by State and local agencies need a camera housing enclosure that is mounted on a pole. Red light camera systems typically employ two closely spaced inductive loops embedded in the pavement just before the limit line, to measure the speed of vehicles.

Using the speed measured, the system predicts if a particular vehicle will not be able to stop before entering the intersection, and takes two photographs of the event. The first photo shows the vehicle just before it enters the intersection, with the light showing red, and the second photo, taken a second or two later, shows the vehicle when it is in the intersection. Laws such as Florida Statute Sec. 316.605 provide that “all letters, numerals, printing, writing, the registration decal, and the alphanumeric designation shall be clear and distinct and free from defacement, mutilation, grease, and other obscuring matter, so that they will be plainly visible and legible at all times 100 feet from the rear or front.”

The Red Light Camera Privacy Filter results in a “clear and distinct” view of the tag so that it is “plainly visible and legible at all times 100 feet from the rear or front” so that anyone can read the registration decal, and the alphanumeric designation. Notably only when the viewing angle is greater than 30 degrees that the light blocking action of the Red Light Camera Privacy Filter takes place and the tag appears black when viewed from that angle.

### 4. DESCRIPTION OF THE RELATED ART

The use of red light cameras is very controversial. Many motorists see it as a money making endeavor where state and local governments hire private companies that keep the majority of the revenue generated by the red light cameras with little or no oversight by government. The prior art includes efforts to attempt to defeat the red light camera by using sprays or plastic covers that claim to diffuse light to make the tag unreadable and distorted to traffic cameras when viewed at an angle. Sprays and films that claim to diffuse or distort light being reflected from a tag may or may not work depending on a combination of factors including object contrast and size, background, brightness (luminance) and structure (texture), glare produced by other light sources, distance between the image and the observer, and the time available to search for the object. The Red Light Camera Privacy Filter does away with those factors by simply blocking light altogether rather than relying upon distortion.

What is claimed:

1. A method for preventing a red light camera from taking a photograph of a vehicle's tag by the application of a polarized sheet of plastic that is applied vertically to the inside of a polyurethane outer shell that prevents light from being reflected from the tag when the viewing angle is more than 30 degrees.
